(19) United States
(12) Patent Application Publication
(10) Pub. No.: US 2025/0068502 A1
(43) Pub. Date: Feb. 27, 2025

(54) ESTIMATION APPARATUS, ESTIMATION METHOD, AND PROGRAM

(71) Applicant: Nippon Telegraph and Telephone Corporation, Tokyo (JP)

(72) Inventors: Shun MATSUMOTO, Musashino-shi, Tokyo (JP); Kensuke TAKAHASHI, Musashino-shi, Tokyo (JP); Satoshi KONDO, Musashino-shi, Tokyo (JP); Masaru SAKAI, Musashino-shi, Tokyo (JP)

(21) Appl. No.: 18/726,448

(22) PCT Filed: Jan. 12, 2022
(86) PCT No.: PCT/JP2022/000674

§ 371 Date: Jul. 3, 2024

(51) Int. Cl. G06F 11/07

(52) U.S. Cl. CPC G06F 11/079

(57) ABSTRACT

An estimation device includes an abnormality score calculation unit that calculates an abnormality score indicating a degree of deviation from a normal time from a metric obtained by quantifying an activity of each of the plurality of services and a trace in which time information and a call order of processing of each of the plurality of services are recorded, a failure occurrence service estimation unit that estimates a service in which a failure has occurred based on the abnormality score, and a root-cause estimation unit that estimates a root-cause based on an abnormality score of a metric of the service in which the failure has occurred.

### TECHNICAL FIELD

The present invention relates to an estimation device, an estimation method, and a program.

### BACKGROUND ART

In recent years, a microservice architecture in which an application is configured by a combination of microservices has attracted attention. In a microservice architecture, while improvement in development speed and ease of scaling are expected, operation management tends to be complicated. In order to support operation management, an application performance management (APM) tool for collectively managing monitoring data and a method for automatically performing failure detection have been proposed.

The APM tool aggregates three types of monitoring data: metrics, traces, and logs, and assists in monitoring the operator. Some APM tools are capable of failure detection based on metrics. In the technique of Non Patent Literature 1, failure detection and estimation of a failure occurrence service are performed based on the service response time included in the trace. In the technique of Non Patent Literature 2, failure detection is performed based on a service response time and a service call order included in the trace. In addition, in the technique of Non Patent Literature 3, failure detection and estimation of a service in which the failure has occurred are performed based on a service response time, service call information, and a response code of a service included in metrics and traces.

### CITATION LIST

### Non Patent Literature

Non Patent Literature 1: J. Grohmann, et al., “SuanMing: Explainable Prediction of Performance Degradations in Microservice Applications”, ICPE '21
Non Patent Literature 2: S. Nedelkoski, et al., “Anomaly Detection from System Tracing Data Using Multimodal Deep Learning”, IEEE CLOUD '19
Non Patent Literature 3: X. Zhou, et al., “Latent error prediction and fault localization for microservice applications by learning from system trace logs”, ESEC/FSE '19

### SUMMARY OF INVENTION

### Technical Problem

In the related art, a failure occurrence service can be detected using an APM tool, but an operator needs to analyze metrics, traces, and logs by himself/herself in order to investigate a root-cause. Although metrics are required to estimate the root-cause, the metrics are not utilized in the related art. In Non Patent Literature 1 and Non Patent Literature 2, since metrics are not used, it is impossible to estimate the root-cause. In Non Patent Literature 3, metrics and traces are used together, but only used for failure occurrence service estimation, and utilization for root-cause estimation is not considered.

The present invention has been made in view of the above, and an object thereof is to estimate a failure occurrence service and to estimate a root-cause of the failure.

### Solution to Problem

An estimation device of an aspect of the present invention is an estimation device that estimates a service in which a failure has occurred in a monitored service configured by combining a plurality of services and estimates a root-cause of the failure, the estimation device including an abnormality score calculation unit that calculates an abnormality score indicating a degree of deviation from a normal time from a metric obtained by quantifying an activity of each of the plurality of services and a trace in which, time information and a call order of processing of each of the plurality of services are recorded, a failure occurrence service estimation unit that estimates a service in which a failure has occurred based on the abnormality score, and a root-cause estimation unit that estimates a root-cause based on an abnormality score of a metric of the service in which the failure has occurred.

An estimation method of an aspect of the present invention is an estimation method for estimating a service in which a failure has occurred in a monitored service configured by combining a plurality of services and estimating a root-cause of the failure occurrence, the estimation method including, by a computer, calculating an abnormality score indicating a deviation from a normal time from a metric obtained by quantifying an activity of each of the plurality of services and a trace in which time information and a call order of processing of each of the plurality of services are recorded, estimating a service in which a failure has occurred based on the abnormality score, and estimating a root-cause based on an abnormality score of a metric of a service in which the failed has occurred.

### Advantageous Effects of Invention

According to the present invention, it is possible to estimate a failure occurrence service and estimate a root-cause of the failure.

### BRIEF DESCRIPTION OF DRAWINGS

FIG. 1 is a functional block diagram illustrating an example of a configuration of an estimation device of the present embodiment.

FIG. 2 is a diagram illustrating an example of metrics.

FIG. 3 is a diagram illustrating an example of a trace.

FIG. 4 is a diagram illustrating an example of trace processing.

FIG. 5 is a diagram illustrating an example of learning processing.

FIG. 6 is a diagram illustrating an example of an abnormality score.

FIG. 7 is a diagram illustrating an example of an abnormality score average.

FIG. 8 is a diagram illustrating an example of display of failure information.

FIG. 9 is a sequence diagram illustrating an example of a flow of processing until monitoring data is stored.

FIG. 10 is a sequence diagram illustrating an example of a flow of processing of estimating a failure occurrence service and estimating a root-cause.

FIG. 11 is a diagram illustrating an example of a hardware configuration of an estimation device.

### DESCRIPTION OF EMBODIMENTS

Hereinafter, an embodiment of the present invention will be described using the drawings.

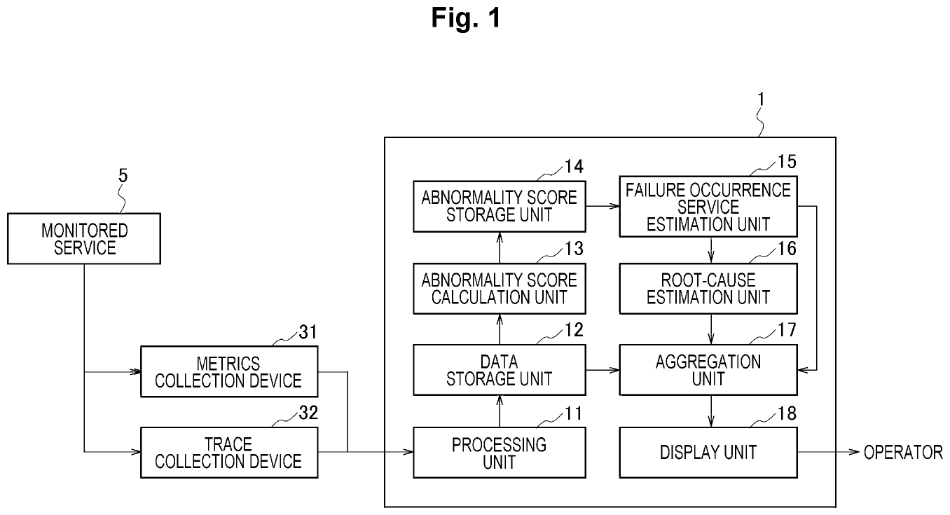

FIG. 1 is a functional block diagram illustrating an example of a configuration of an estimation device of the present embodiment. An estimation device 1 illustrated in the drawing is a device that estimates a failure occurrence service from monitoring data collected from a monitored service 5 and estimates a root-cause of the failure occurrence. The monitored service 5 is, for example, a service using a microservice architecture configured by combining a plurality of microservices. The monitoring data is metrics and traces collected from the monitored service 5. The metrics are data obtained by quantifying the activity of each service. For example, the metrics include a CPU usage rate, memory usage, communication volume, or the like. The trace is data in which time information and a call order of processing of each service are recorded. A metrics collection device 31 collects metrics and a trace collection device 32 collects traces. Commercial technologies with open source software can be used for the metrics collection device 31 and the trace collection device 32.

The estimation device 1 illustrated in FIG. 1 includes a processing unit 11, a data storage unit 12, an abnormality score calculation unit 13, an abnormality score storage unit 14, a failure occurrence service estimation unit 15, a root-cause estimation unit 16, an aggregation unit 17, and a display unit 18.

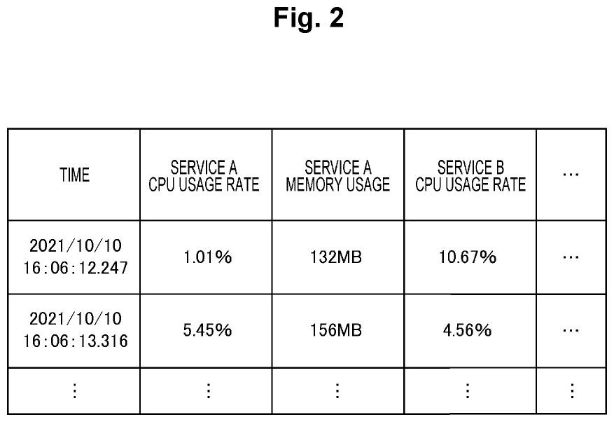

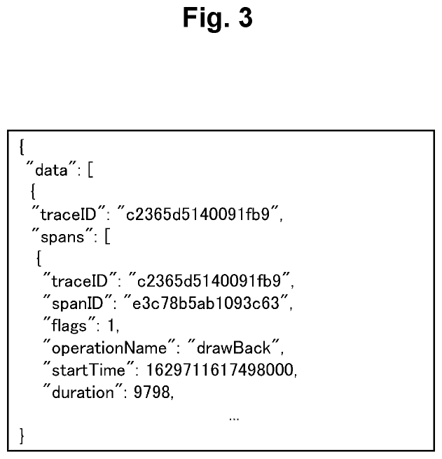

The processing unit 11 stores the metrics in the data storage unit 12 for each time, converts the traces into data of the response time of each service for each time, and stores the data in the data storage unit 12. FIG. 2 illustrates an example of metrics, and FIG. 3 illustrates an example of traces. The trace illustrated in FIG. 3 is data in a JSON format. The processing unit 11 converts the JSON format trace into a response time of each service.

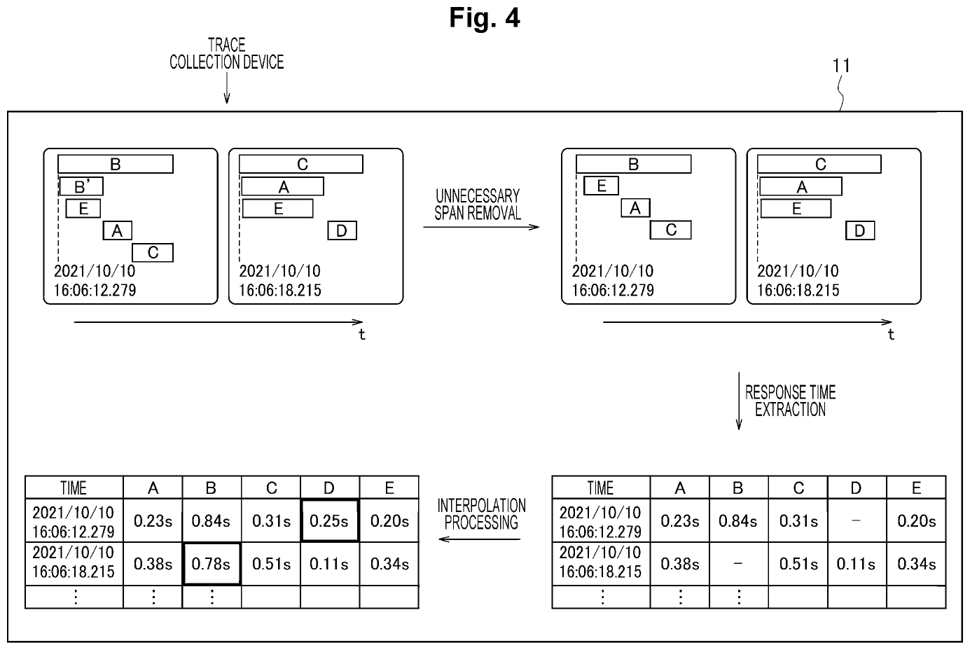

Here, an example of trace processing by the processing unit 11 will be described with reference to FIG. 4. The trace is data in which a series of processing from a request to a response to the monitored service 5 is recorded in a form of a span in each service. The span is data in which time information of processing and a call order of each service are recorded. In the upper part of FIG. 4, the span is represented by a rectangle. The horizontal length of the rectangle indicates the response time. The upper and lower rows of the rectangles indicate the calling order. A frame including a plurality of spans in the upper part of FIG. 4 is one trace, and is a series of processing from a request to a response to the monitored service 5.

The processing unit 11 removes an unnecessary span having low importance in failure detection from the trace received from the trace collection device 32. The unnecessary span is, for example, a span in which only processing related to request transmission and reception between services is recorded without recording processing of the service itself. By removing the unnecessary span, the number of dimensions (the number of columns in the table) can be reduced, and the curse of dimensions in learning of the multivariate time-series model by the abnormality score calculation unit 13 described later can be avoided.

After removing the unnecessary span, the processing unit 11 extracts the response time of each service from the trace, and generates tabular data indicating the response time of each service for each time of the trace. Each row in the table corresponds to one trace.

Since the multivariate time-series model of the abnormality score calculation unit 13 does not allow deficiencies, the processing unit 11 performs time-interpolation processing such as linear interpolation on the missing part in the table and stores the processed trace in the data storage unit 12. The thick frame in the table on the left side of the lower part of FIG. 4 is a portion where the deficiencies are interpolated.

Note that the processing unit 11 may combine the metrics and the processed traces for each time, and store the combined data in the data storage unit 12. For example, the processing unit 11 may combine metrics in accordance with the time of the trace, or may combine the trace and the metrics at predetermined time intervals.

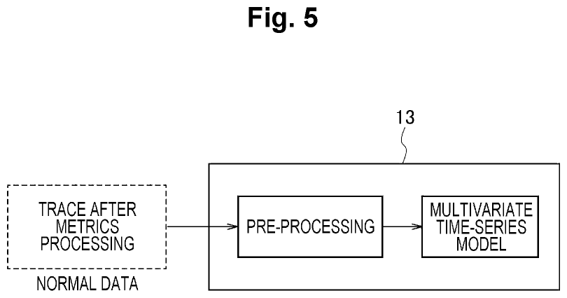

The abnormality score calculation unit 13 calculates, from the metrics and traces stored in the data storage unit 12, an abnormality score indicating the degree of deviation from the normal time for each of the metrics of each service and the response time of each service using the multivariate time-series model. As illustrated in FIG. 5, the abnormality score calculation unit 13 learns the behavior at the normal time by inputting the metrics and traces at the normal time to the multivariate time-series model after preprocessing. As a result, it is possible to ascertain the correlation across the data type (column direction) and the time (row direction), and to perform accurate learning.

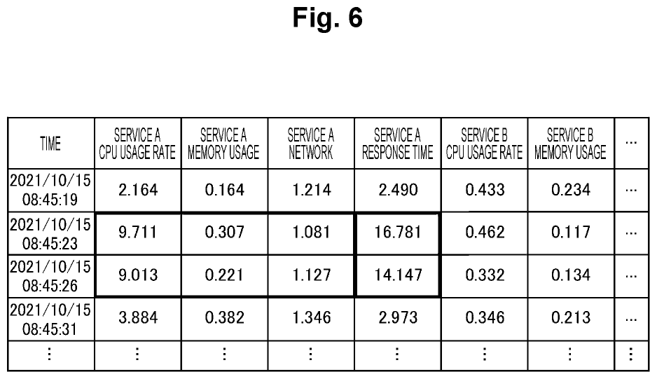

At the time of estimation, the abnormality score calculation unit 13 operates at a timing when monitoring data is generated, and outputs an abnormality score for one hour in response to inputs for a plurality of hours. For example, assuming that the timing at which the monitoring data is generated is time t, the abnormality score calculation unit 13 inputs metrics and traces corresponding to M times from time t-M to time t to the multivariate time-series model, and outputs the abnormality score at time t. M is the window size in the multivariate time-series model. The abnormality score storage unit 14 accumulates the abnormality scores up to time t. FIG. 6 illustrates an example of the abnormality score. Each row indicates an abnormality score for one hour. The larger the numerical value, the larger the deviation from the normal time. Note that a thick frame in the abnormality score is a portion focused on by the failure occurrence service estimation unit 15 and the root-cause estimation unit 16 described later.

The failure occurrence service estimation unit 15 estimates the failure occurrence service using the abnormality score accumulated in the abnormality score storage unit 14. Specifically, the failure occurrence service estimation unit 15 focuses on the response time that is an index likely to be affected by the failure, and estimates the failure occurrence service by searching for a portion exceeding the threshold in the response time of each service from the abnormality score. In the example of FIG. 6, since the abnormality score in the thick frame portion of the response time of a service A exceeds the predetermined threshold, the failure occurrence service estimation unit 15 estimates that a failure has occurred in the service A in a time period in which the abnormality score exceeds the threshold.

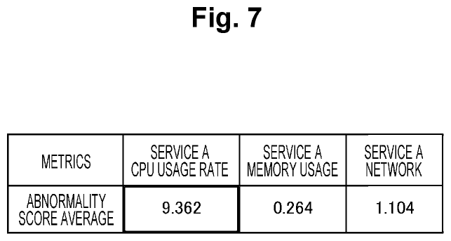

The root-cause estimation unit 16 calculates an abnormality score average of each metric for the service/time period in which the failure has occurred determined by the failure occurrence service estimation unit 15, and estimates the root-cause based on the abnormality score average. For example, the root-cause estimation unit 16 estimates, as the root-cause, one in which the abnormality score average exceeds a threshold or one in which the abnormality score average is the largest. In the example of FIG. 6, the abnormality score average of the metrics of the service A in the thick frame is calculated. FIG. 7 illustrates an example of the calculated abnormality score average. In the example of FIG. 7, since the abnormality score of the CPU usage rate is large, the root-cause estimation unit 16 estimates that the root-cause is that the load on the CPU of the server or the virtual server of the service A is large.

The aggregation unit 17 aggregates failure information obtained by the failure occurrence service estimation unit 15 and the root-cause estimation unit 16. The aggregation unit 17 may aggregate metrics and traces related to failures, or may aggregate logs obtained from the monitored service 5.

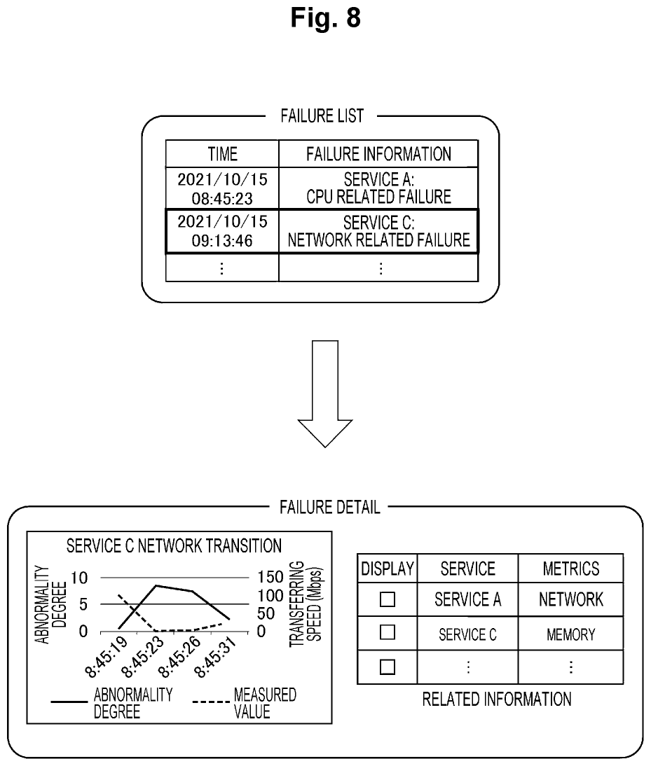

The display unit 18 presents the failure information in a format that is easy for the operator to ascertain. FIG. 8 illustrates an example of display. On a failure list screen, the failure occurrence time and the failure information are displayed so that the situation can be immediately confirmed. The failure information indicates the failure occurrence service and the root-cause estimated by the estimation device 1. When the operator selects a failure for which details are to be confirmed, the failure details are displayed. In the failure details, the abnormality degree of the root-cause and the transition of the measured value, and the service whose abnormality score increased in the same time period and its metrics can be confirmed as the related information. The transition of the related information can also be confirmed by checking “display”.

Next, an example of the operation of the estimation device 1 of the present embodiment will be described.

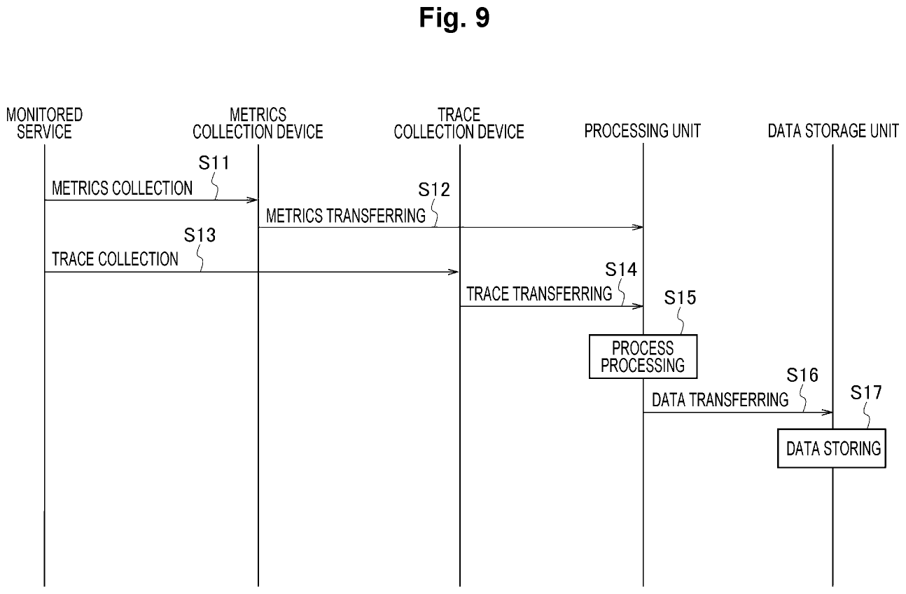

FIG. 9 is a sequence diagram illustrating an example of a flow of processing from collection to storage of the metrics and the traces from the monitored service 5.

In Steps S11 and S12, the metrics collection device 31 collects the metrics from the monitored service 5 and transfers the metrics to the processing unit 11.

In Steps S13 and S14, the trace collection device 32 collects the traces from the monitored service 5 and transfers the traces to the processing unit 11.

In Step S15, the processing unit 11 processes the trace into a table format. The processing unit 11 may combine the metrics and the processed traces.

In Steps S16 and S17, the processing unit 11 transfers the metrics and the processed trace to the data storage unit 12, and stores the data in the data storage unit 12.

Through the above processing, monitoring data that can be used for abnormality score calculation or learning by the abnormality score calculation unit 13 is stored in the data storage unit 12. At the time of learning, the abnormality score calculation unit 13 collectively takes data at the normal time and causes the multivariate time-series model to learn. At the time of estimation, when the monitoring data is stored in the data storage unit 12, the monitoring data is transmitted to the abnormality score calculation unit 13, and the abnormality score is calculated.

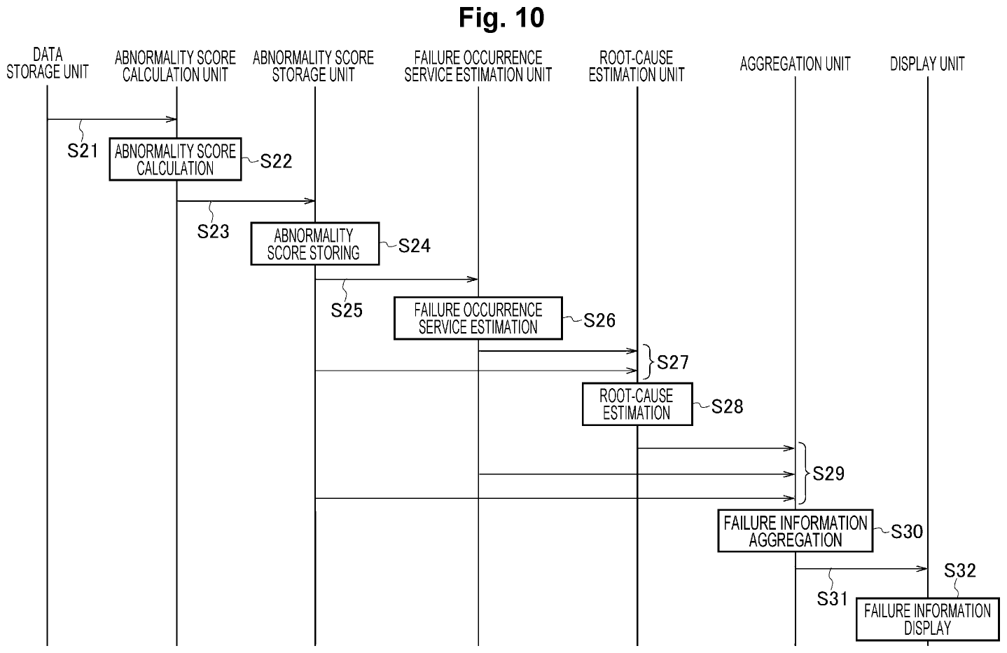

FIG. 10 is a sequence diagram illustrating an example of a flow of processing of estimating a failure occurrence service and estimating a root-cause.

When the data is stored by the processing of FIG. 9, monitoring data necessary for calculating the abnormality score is transmitted from the data storage unit 12 to the abnormality score calculation unit 13 in Step S21.

In Step S22, the abnormality score calculation unit 13 calculates an abnormality score.

In Steps S23 and S24, the abnormality score calculation unit 13 transmits the calculated abnormality score to the abnormality score storage unit 14, and stores the abnormality score in the abnormality score storage unit 14.

When the abnormality score is transmitted from the abnormality score storage unit 14 to the failure occurrence service estimation unit 15 in Step S25, the failure occurrence service estimation unit 15 estimates the service in which the failure has occurred based on the abnormality score in Step S26.

When the service in which the failure has occurred is estimated, in Step S27, the failure occurrence service information indicating the service in which the failure has occurred is transmitted from the failure occurrence service estimation unit 15 to the root-cause estimation unit 16, and the abnormality score is transmitted from the abnormality score storage unit 14 to the root-cause estimation unit 16.

In Step S28, the root-cause estimation unit 16 estimates the root-cause of the failure.

In Step S29, the root-cause is transmitted from the root-cause estimation unit 16 to the aggregation unit 17, the failure occurrence service information is transmitted from the failure occurrence service estimation unit 15 to the aggregation unit 17, and the abnormality score is transmitted from the abnormality score storage unit 14 to the aggregation unit 17.

In Step S30, the aggregation unit 17 aggregates the received information.

In Step S31, the aggregated failure information is transmitted to the display unit 18, and in Step S32, the display unit 18 displays the failure information.

Through the above processing, the failure occurrence service and the root-cause of the failure are estimated and presented to the operator.

As described above, the estimation device 1 according to the present embodiment is the estimation device 1 that estimates the failure occurrence service of the monitored service 5 configured by combining a plurality of services and estimates the root-cause of the failure occurrence. The estimation device 1 includes the abnormality score calculation unit 13 that calculates an abnormality score indicating a degree of deviation from a normal time from a metric obtained by quantifying an activity of each of the plurality of services and a trace in which time information and a call order of processing of each of the plurality of services are recorded, a failure occurrence service estimation unit 15 that estimates a service in which a failure has occurred based on the abnormality score, and the root-cause estimation unit 16 that estimates a root-cause based on an abnormality score of a metric of the service. The estimation device 1 can estimate a failure occurrence service and its root-cause by analyzing a combination of the metrics and the traces, and present the failure occurrence service and its root-cause to an operator. As a result, the load on the operator can be reduced, and the average recovery time can be shortened.

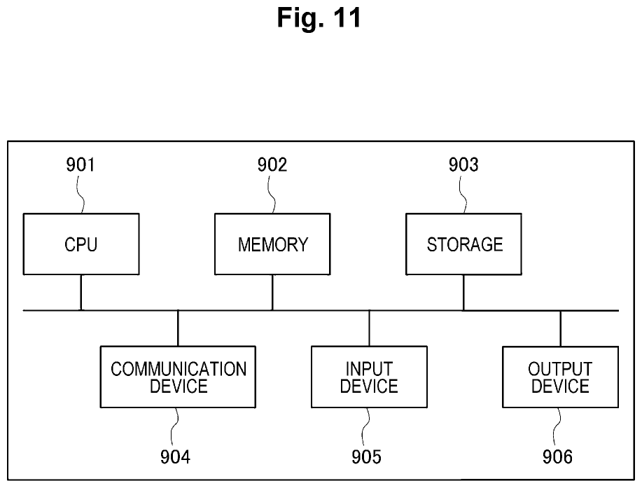

For example, as illustrated in FIG. 11, a general-purpose computer system including a central processing unit (CPU) 901, a memory 902, a storage 903, a communication device 904, an input device 905, and an output device 906 can be used as the estimation device 1 described above. In this computer system, the CPU 901 executes a predetermined program loaded on the memory 902, thereby implementing the estimation device 1. This program can be recorded on a computer-readable recording medium such as a magnetic disk, an optical disc, or a semiconductor memory, or can be distributed via a network.

### REFERENCE SIGNS LIST

1 Estimation device
11 Processing unit
12 Data storage unit
13 Abnormality score calculation unit
14 Abnormality score storage unit
15 Failure occurrence service estimation unit
16 Root-cause estimation unit
17 Aggregation unit
18 Display unit

1. An estimation device configured to estimate a service in which a failure has occurred in a monitored service configured by combining a plurality of services and estimate a root-cause of the failure, the estimation device comprising:
an abnormality score calculation unit, comprising one or more processors, configured to calculate an abnormality score indicating a degree of deviation from a normal time from a metric obtained by quantifying an activity of each of the plurality of services and a trace in which time information and a call order of processing of each of the plurality of services are recorded;
a failure occurrence service estimation unit, comprising one or more processors, configured to estimate a service in which a failure has occurred based on the abnormality score; and
a root-cause estimation unit, comprising one or more processors, configured to estimate a root-cause based on an abnormality score of a metric of the service in which the failure has occurred.

2. The estimation device according to claim 1, further comprising:
a processing unit, comprising one or more processors, configured to convert the trace into a response time of each of the plurality of services for each time, wherein
the abnormality score calculation unit is configured to calculate an abnormality score from a metric and a trace for each time.

3. The estimation device according to claim 2, wherein
the processing unit is configured to remove processing with low importance in failure detection from the trace, extract a response time of each of the plurality of services, and interpolate the response time for a service whose response time cannot be extracted.

4. The estimation device according to claim 1, wherein
the abnormality score calculation unit is configured to input metrics and traces at a normal time to a multivariate time-series model to learn behavior at a normal time, and input the metrics and the traces to the multivariate time-series model at a time of estimation to calculate the abnormality score.

5. The estimation device according to claim 1, wherein
the failure occurrence service estimation unit is configured to estimate a service in which the abnormality score exceeds a predetermined threshold as a service in which a failure occurs, and
the root-cause estimation unit is configured to obtain an average of abnormality scores of metrics in a time period of failure occurrence in the service in which the failure has occurred, and estimate the root-cause based on the obtained average value.

6. An estimation method for estimating a service in which a failure has occurred in a monitored service configured by combining a plurality of services and estimating a root-cause of the failure occurrence,
the estimation method comprising, by a computer:
calculating an abnormality score indicating a deviation from a normal time from a metric obtained by quantifying an activity of each of the plurality of services and a trace in which time information and a call order of processing of each of the plurality of services are recorded;
estimating a service in which a failure has occurred based on the abnormality score; and
estimating a root-cause based on an abnormality score of a metric of the service in which the failure has occurred.

7. A non-transitory computer readable medium storing a program, wherein execution of the program causes a computer to operate as each unit of the estimation device according to claim 1.
